(19) United States
(12) Patent Application Publication
(10) Pub. No.: US 2007/0019088 A1
(43) Pub. Date: Jan. 25, 2007

(54) Camera module and mobile phone

(75) Inventor: Kyozo Saito, Fukushima-ken (JP)

Correspondence Address: BEYER WEAVER & THOMAS, LLP, P.O. BOX 70250, OAKLAND, CA, 94612-0250, US

(73) Assignee: ALPS ELECTRIC CO., LTD.

(21) Appl. No.: 11/415,586

(22) Filed: May 1, 2006

(30) Foreign Application Priority Data
Jul. 19, 2005 (JP) 2005-209002

(51) Int. Cl. H04N 3/14; H04N 5/335

(52) U.S. Cl. 348/294

(57) ABSTRACT

A mobile phone includes a camera module including an imaging element in which light-receiving pixel groups for photoelectrically converting incident light are formed on a substrate, and an input/output unit that processes signals from the imaging element, and a control unit that identifies the imaging element on the basis of signals from the camera module. The light-receiving pixel groups of the imaging element are composed of a plurality of normal light-receiving pixels capable of detecting incident light, and a plurality of defective light-receiving pixels that does not detect incident light. The input/output unit outputs position information of the defective light-receiving pixels, and the control unit identifies the imaging element on the basis of the position information of the defective light-receiving pixels.

### BACKGROUND OF THE INVENTION

1. Field of the Invention

The present invention relates to a camera module having an imaging element that is formed by integrating photoelectric conversion pixels and a mobile phone having the camera module built therein, more particularly, to a camera module capable of identifying an imaging element and a mobile phone having the camera module built therein.

2. Description of the Related Art

Recently, a mobile phone having a camera built therein has been widely used. Moreover, the mobile phone is equipped with various functions, such as electronic money technology. Here, it is necessary to individually identify the mobile phone for security measures. In a mobile phone according to the related art, generally, a nonvolatile memory is built in the mobile phone so that information, such as serial numbers, is stored in the memory, and then a method of using such a configuration is adopted (for example, see JP-B-6-42691).

As described above, since a camera is now commonly mounted in a mobile phone, it is possible to individually identify a mobile phone by individually identifying a camera module. However, if a memory is built either in the mobile phone or the camera module and the memory stores specific information, the mobile phone inevitably requires a storage region for the memory, functions to write and read information and to generate identification numbers, and a managing structure, which leads to increasing cost and deters miniaturization of the mobile phone.

### SUMMARY OF THE INVENTION

The present invention has been finalized in view of the inherent drawbacks in the related art, and it is an object of the present invention to provide a camera module and a mobile phone capable of individual identification without preparing a memory.

In order to solve the above-described problems, the camera module according to an aspect of the invention includes an imaging element in which light-receiving pixel groups for photoelectrically converting incident light are formed on a substrate, and an input/output unit that processes signals from the imaging element. In this case, the light-receiving pixel groups of the imaging element include an image region through which incident light is transmitted and a non-image region through which incident light is not transmitted, and the non-image region is formed around the image region. Further, the non-image region includes a plurality of defective light-receiving pixels that is formed by breaking arbitrary light-receiving pixels, and the input/output unit outputs position information of the defective light-receiving pixels.

In the above-mentioned camera module, each of the light-receiving pixels includes a photodiode and an amplifier, and each of the defective light-receiving pixels is formed by breaking the photodiode.

According to another aspect of the invention, a mobile phone includes: a camera module including an imaging element in which light-receiving pixel groups for photoelectrically converting incident light are formed on a substrate, and an input/output unit that processes signals from the imaging element; and a control unit which identifies the imaging element on the basis of signals from the camera module. In this case, the light-receiving pixel groups of the imaging element are composed of a plurality of normal light-receiving pixels capable of detecting incident light, and a plurality of defective light-receiving pixels that does not detect incident light. Further, the input/output unit outputs position information of the defective light-receiving pixels, and the control unit identifies the imaging element on the basis of the position information of the defective light-receiving pixels.

In the above-mentioned mobile phone, the light-receiving pixel groups include an image region through which is transmitted and a non-image region through which is not transmitted, and the non-image region formed around the image region. Further, the control unit identifies the imaging element on the basis of the position information of the defective light-receiving pixels, which are formed in the non-image region.

In the above-mentioned mobile phone, each of the defective light-receiving pixels in the non-image region is formed by breaking an arbitrary light-receiving pixel.

### BRIEF DESCRIPTION OF THE DRAWINGS

FIG. 1 is a block diagram of a mobile phone according to an embodiment of the invention;

FIG. 2 is a schematic view illustrating a configuration of an imaging element;

FIG. 3 is a view illustrating arrangement of light-receiving pixels forming the imaging element;

FIG. 4 is a view illustrating detection of position information of defective light-receiving pixels;

FIG. 5 is a view illustrating arrangement of light-receiving pixels forming an imaging element according to a second embodiment;

FIG. 6 is a view illustrating an equivalent circuit of a normal light-receiving pixel; and

FIG. 7 is a view illustrating an equivalent circuit of a defective light-receiving pixel.

### DESCRIPTION OF THE PREFERRED EMBODIMENT

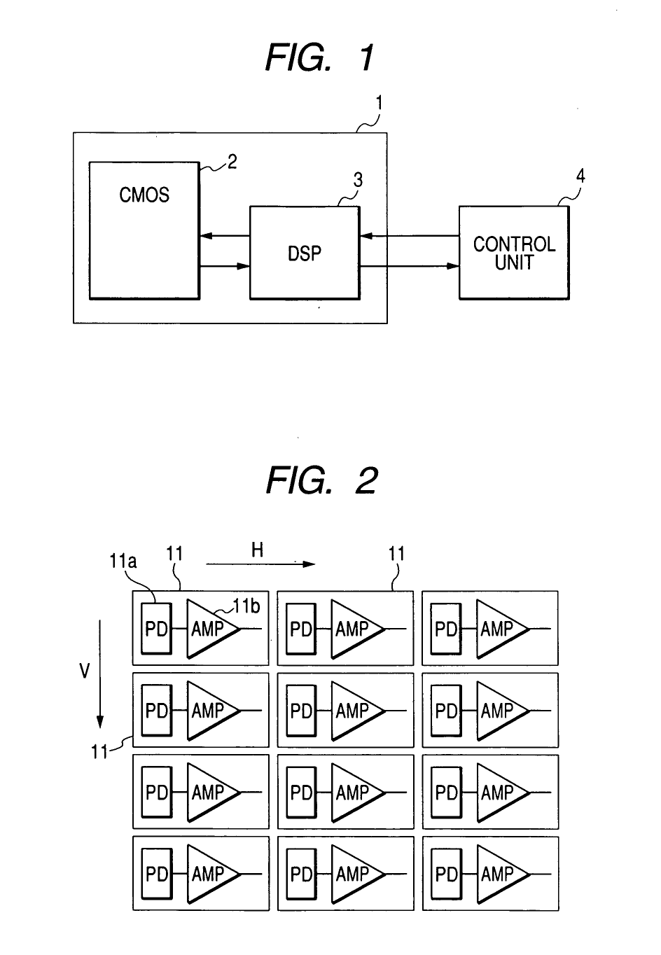

Hereinafter, preferred embodiments of the invention will be described in detail with reference to the accompanying drawings. FIG. 1 is a block diagram of a mobile phone according to an embodiment of the invention. As shown in FIG. 1, the mobile phone according to the present embodiment includes a camera module 1 and a control unit 4, which controls the camera module. The control unit 4 is connected to each part (not shown) forming the mobile phone and performs various processes for realizing the functions of the mobile phone. FIG. 1 shows only the configuration for performing an individual identification of the mobile phone among the various processes.

The camera module 1 includes an imaging element 2 that receives light through a lens (not shown), and an input/output unit 3 that receives signals from the imaging element and transmits signals to the imaging element 2. The imaging element 2 has a structure in which a plurality of light-receiving pixel groups 10 for photoelectrically converting incident light is formed on a substrate, and a CMOS sensor is generally used as the imaging element. The input/output unit 3 is a digital signal processor (DSP), which processes electric signals from the imaging element 2. The input/output unit addresses the light-receiving pixel groups 10 of the imaging element 2 in a predetermined order, and reads the intensity of signal for each pixel.

FIG. 2 is a schematic view illustrating a configuration of the imaging element 2. As shown in FIG. 2, each light-receiving pixel 11 is composed of a photodiode 11a and an amplifier 11b. The photodiode 11a of the light-receiving pixel 11, which has received light, outputs electric signals on the basis of light intensity, and the electric signals are output after being amplified by the amplifier 11b.

The input/output unit 3 sequentially reads signals by addressing the light-receiving pixel groups 10 of the imaging element 2 in an H-direction and a V-direction shown in FIG. 2. Meanwhile, the photodiode outputs only light intensity signals in the present embodiment. However, the photodiode is configured to output RGB color arrangement signals together with the light intensity signals, so that a colorful image can be obtained.

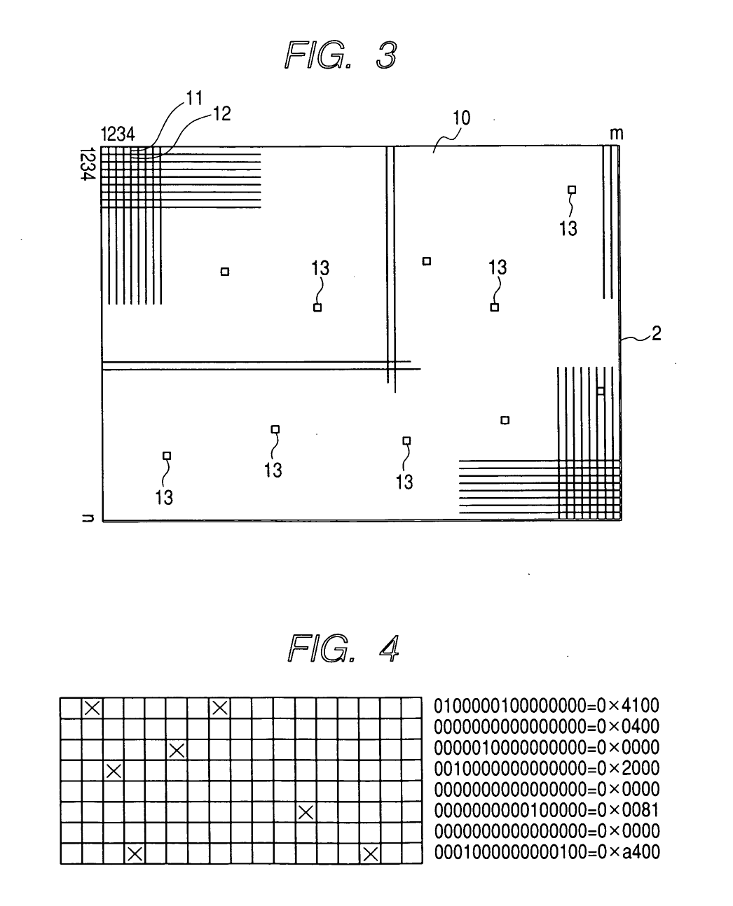

Hereinafter, identification of the imaging element 2 will be described. FIG. 3 is a view illustrating arrangement of the light-receiving pixels 11 forming the imaging element 2. As shown in FIG. 3, in the light-receiving pixel groups 10, m light-receiving pixels 11 are arranged in a transverse direction, and n light-receiving pixels 11 are arranged in a longitudinal direction. Most light-receiving pixels 11 are normal light-receiving pixels 12 that normally operate. Meanwhile, since the imaging element 2 is manufactured by a semiconductor process, some light-receiving pixels 11 become defective light-receiving pixels 13, which do not normally operate. Defective light-receiving pixels 13 are randomly found in the light-receiving pixel groups 10.

Even though light is incident on each of the defective light-receiving pixel 13, the defective light-receiving pixel 13 does not output effective signals. Accordingly, the defective light-receiving pixel itself is indicated by a black point on an image, which is obtained by the imaging element 2. For this reason, a correction process is performed in an image processing stage of the input/output unit 3 or the control unit 4. In the present embodiment, the position of the defective light-receiving pixel 13 is detected by the input/output unit 3 in a stage before the image processing, and position information thereof is output to the control unit 4.

FIG. 4 is a view illustrating detection of the position information of the defective light-receiving pixels 13. Grids shown on the left side in FIG. 4 show a part of the light-receiving pixel groups 10, grids added with ‘x’ indicate defective light-receiving pixels 13, and the rest indicate normal light-receiving pixels 12. Here, four successive light-receiving pixels 11 are set to one unit, the normal light-receiving pixel 12 is indicated by ‘0’, and the defective light-receiving pixel 13 is indicated by ‘1’. As a result, like the numbers shown in the middle of FIG. 4, values in the range of ‘0000’ to ‘1111’ can be obtained. When the values are indicated by hexadecimal numbers, like the number shown on the right side in FIG. 4, each of the values can be indicated by a single-digit number in the range of ‘0x0’ to ‘0xf’. The entire light-receiving pixel groups 10 can be successively indicated by these numerical values.

A plurality of defective light-receiving pixels 13 is included in the light-receiving pixel groups 10, and the defective light-receiving pixels randomly appear respectively. Therefore, data indicating the position of the defective light-receiving pixels 13 as the numerical values can be used as individually identifying marks for the imaging element 2. The amount of data increases when the number of light-receiving pixels forming the light-receiving pixel groups 10. However, it is possible to have a practical amount of data by performing data-compression in the input/output unit 3.

Some defective light-receiving pixels 13 are extracted from the light-receiving pixel groups 10, and coordinates of the extracted defective light-receiving pixels are numerically expressed so as to be used as individual identification marks. The number of the light-receiving pixels 13 to be extracted can be defined depending on security level to be required or occurrence frequency of the defective light-receiving pixel 13.

Position information of the defective light-receiving pixels 13 obtained by the input/output unit 3 as described above is transferred to the control unit 4 so as to be used as individual identification marks. Since the camera module 1 includes information for individual identification, the mobile phone does not need a memory for storing IDs serving as individual identification marks. Accordingly, it is possible to reduce cost. Further, since the defect of the light-receiving pixel 11 occurs during manufacturing, it is difficult to perform an illegal action, such as rewriting. As a result, it is possible to provide a mobile phone having excellent stability in terms of security.

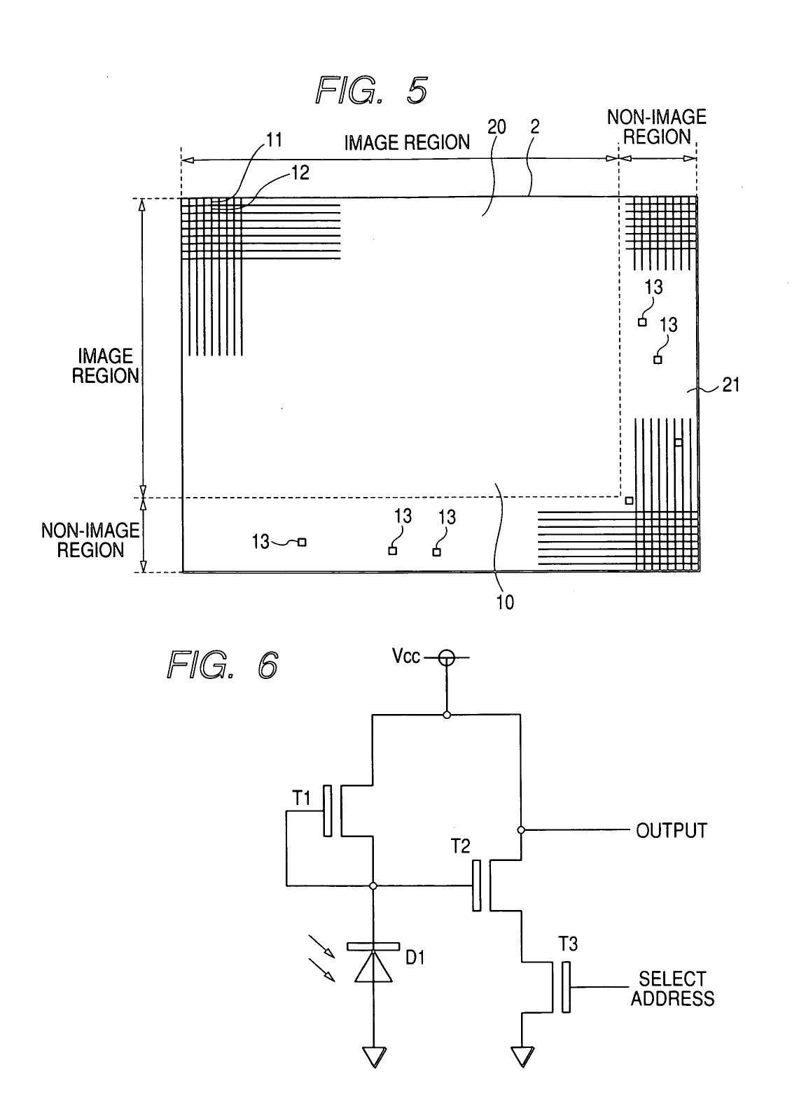

Next, a second embodiment according to the invention will be described. FIG. 5 is a view illustrating arrangement of the light-receiving pixels 11 forming the imaging element 2 according to the second embodiment. According to the second embodiment, the camera module 1 and the control unit 4 are configured in the same manner as the first embodiment as shown in FIG. 1. As shown in FIG. 5, a plurality of light-receiving pixels 11 are arranged in the light-receiving pixel groups 10, and the imaging element is composed of an image region 20 and a non-image region 21 located around the image region 20.

Light entering the imaging element 2 through a lens (not shown) is transmitted through the image region 20, and is not transmitted through the non-image region 21. In other words, while the imaging element 2 forms an image, the non-image region 21 does not function. According to the present embodiment, a plurality of defective light-receiving pixels 13 is formed in the non-image region 21.

The defective light-receiving pixels 13 are formed by breaking arbitrary normal light-receiving pixels 12 arranged in the non-image region 21. FIG. 6 is a view illustrating an equivalent circuit of the normal light-receiving pixel 12. When light is not incident on a photodiode D1, currents do not flow to the photodiode D1. Therefore, the electric potential of a T2 becomes substantially the same as Vcc, and an output voltage becomes about zero. On the other hand, when light is incident on the D1, photoelectric effect makes currents flow into the D1, so that the electric potential of the T2 decreases and the output voltage increases.

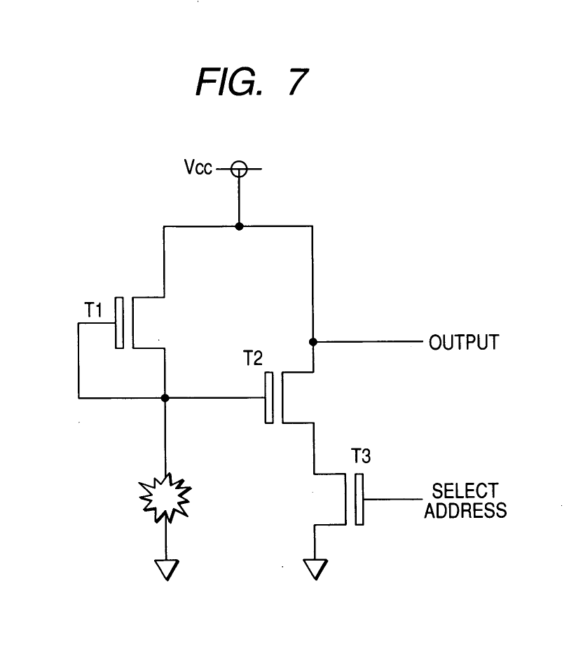

FIG. 7 is a view illustrating an equivalent circuit when the defective light-receiving pixel 13 is used as a normal light-receiving pixel 12. As shown in FIG. 7, the defective light-receiving pixel 13 is formed by breaking the photodiode D1 of the normal light-receiving pixel 12. An external energy capable of converging, such as a laser beam, can be used to break the photodiode D1. When the photodiode D1 is broken as described above, the T2 always remains at a high electric potential and the output voltage is zero almost all the time. The position of the defective light-receiving pixel 13 can be detected by detecting the electric potential of the T2 by means of the input/output unit 3.

As the defective light-receiving pixel 13 is formed by artificially breaking the normal light-receiving pixel 12, the defective light-receiving pixel 13 can be formed at an arbitrary position in the light-receiving pixel groups 10. Therefore, the defective light-receiving pixel 13 can be formed not in the translucent image region 20, which is necessary to form an image by light transmission, but in the non-image region 21 through which light is not transmitted. As a result, it is possible to prevent image formation in the imaging element 2 from being affected.

The input/output unit 3 detects the positions of the defective light-receiving pixels 13 of the imaging element 2 in the same manner as the first embodiment, and outputs the detected positions to the control unit 4 as position information. The control unit 4 uses the position information as individual identification marks.

Although the preferred embodiments of the invention have been described above, the application of the invention is not limited to the above-described embodiments and can be modified in various forms within the scope of the invention.

According to the invention, a camera module includes an image region through which incident light is transmitted and a non-image region through which incident light is not transmitted, and the non-image region is formed around the image region. The non-image region has a plurality of defective light-receiving pixels that is formed by breaking arbitrary light-receiving pixels. The input/output unit outputs position information of the defective light-receiving pixels. The control unit identifies the imaging element on the basis of the position information of the defective light-receiving pixels. Therefore, the mobile phone does not need a memory for individual identification, which may lead to cost reduction. Further, it is difficult to perform an illegal action, such as rewriting, and thus the mobile phone may have excellent stability in terms of security.

According to the camera module of the invention, each of the light-receiving pixels includes a photodiode and an amplifier, and each of the defective light-receiving pixels is formed by breaking the photodiode. Therefore, each of the defective light-receiving pixels reliably outputs an abnormal signal, so that individual identification can be reliably performed.

According to a mobile phone of the invention, the light-receiving pixel groups of the imaging element are composed of a plurality of normal light-receiving pixels capable of detecting incident light, and a plurality of defective light-receiving pixels that does not detect incident light. The input/output unit outputs the position information of the defective light-receiving pixels, and the control unit identifies the imaging element on the basis of the position information of the defective light-receiving pixels, so that the position information of the defective light-receiving pixel of the imaging element can be used as individual identification marks of the mobile phone. Therefore, the mobile phone does not need a memory for individual identification, which may lead to cost reduction. Further, it is difficult to perform an illegal action, such as rewriting, and thus the mobile phone may have excellent stability in terms of security.

1. A camera module comprising:
an imaging element in which light-receiving pixel groups for photoelectrically converting incident light are formed on a substrate; and
an input/output unit that processes signals from the imaging element,
wherein the light-receiving pixel groups of the imaging element include an image region through which incident light is transmitted and a non-image region through which incident light is not transmitted, and the non-image region is formed around the image region,
the non-image region includes a plurality of defective light-receiving pixels that is formed by breaking arbitrary light-receiving pixels, and
the input/output unit outputs position information of the defective light-receiving pixels.

2. The camera module according to claim 1,
wherein each of the light-receiving pixels includes a photodiode and an amplifier, and each of the defective light-receiving pixels is formed by breaking the photodiode.

3. A mobile phone comprising:
a camera module including an imaging element in which light-receiving pixel groups for photoelectrically converting incident light are formed on a substrate, and an input/output unit that processes signals from the imaging element; and
a control unit that identifies the imaging element on the basis of signals from the camera module,
wherein the light-receiving pixel groups of the imaging element are composed of a plurality of normal light-receiving pixels capable of detecting incident light, and a plurality of defective light-receiving pixels that does not detect incident light,
the input/output unit outputs position information of the defective light-receiving pixels, and
the control unit identifies the imaging element on the basis of the position information of the defective light-receiving pixels.

4. The mobile phone according to claim 3,
wherein the light-receiving pixel groups includes an image region through which is transmitted and a non-image region through which is not transmitted, and the non-image region formed around the image region, and
the control unit identifies the imaging element on the basis of the position information of the defective light-receiving pixels that are formed in the non-image region.

5. The mobile phone according to claim 4,
wherein each of the defective light-receiving pixels in the non-image region is formed by breaking an arbitrary light-receiving pixel.
